(19) United States
(12) Patent Application Publication
(10) Pub. No.: US 2001/0046580 A1
(43) Pub. Date: Nov. 29, 2001

(54) Double-face velour fabric articles having improved dynamic insulation performance

(75) Inventors: Moshe Rock, Andover, MA (US); William Lie, Methuen, MA (US); Douglas Lumb, Methuen, MA (US); Bhupesh Dua, Haverhill, MA (US); Edward P. Dionne, South Paris, ME (US)

Correspondence Address: TIMOTHY A. FRENCH, Fish & Richardson P.C., 225 Franklin Street, Boston, MA, 02110-2804, US

(73) Assignee: Malden Mills Industries, Inc., Massachusetts corporation

(21) Appl. No.: 09/883,643

(22) Filed: Jun. 18, 2001

Related U.S. Application Data
(62) Division of application No. 09/347,825, filed on Jul. 2, 1999.

(51) Int. Cl. B32B 3/02; D04H 11/00; B32B 33/00; D04B 9/00

(52) U.S. Cl. 428/92; 442/304; 428/85

(57) ABSTRACT

A double-face velour fabric article consists of a knitted fabric body having a technical face formed by a micro-denier filament stitch yarn and a technical back formed by a micro-denier filament loop yarn. The fabric body has a velour surface formed at both the technical back and the technical face. The fabric body has a permeability of about 80 ft³/ft²/min, or less, under a pressure difference of ½ inch of water across the knitted fabric body.

The invention relates to double-face velour fabric articles.

### BACKGROUND OF THE INVENTION

Double-face velour fabric articles having opposite raised surfaces, e.g. by processes of sanding, brushing or napping, are known to have good insulation performance under static conditions, i.e. in calm or still air with no wind blowing through the fabric. However, the insulating performance of these fabric articles drops rapidly under dynamic conditions, i.e., in a chilling wind. As a result, consumers wearing a double-face velour fabric article find it necessary to also wear a shell, e.g., of woven nylon or other low permeability material, when conditions are likely to be windy.

It is also known to increase the thermal insulation performance of double-face velour fabric articles by incorporating a relatively coarser stitch yarn and/or by tightening the stitch. However, these approaches result in fabric articles with very poor stretch, increased stiffness and increased weight.

### SUMMARY OF THE INVENTION

According to one aspect of the invention, a double-face velour fabric article consists of a knitted fabric body having a technical face formed by a micro-denier filament stitch yarn and a technical back formed by a micro-denier filament loop yarn, the fabric body having a velour surface formed at both the technical back and the technical face, and the fabric body having a permeability of about 80 ft³/ft²/min, or less, under a pressure difference of ½ inch of water across the knitted fabric body.

Preferred embodiments of this aspect of the invention may include one or more the following additional features. The micro-denier filament loop yarn is textured; it has an overall denier in the range of about 70 denier to 300 denier, and preferably about 150 denier; and it has a filament count in the range of about 100 filaments to 300 filaments. Preferably, the micro-denier filament loop yarn has a denier per filament (dpf) in the range of about 1.5 dpf to 0.5 dpf, and preferably about 1 dpf. The micro-denier filament stitch yarn is textured; it has an overall denier in the range of about 50 denier to 150 denier, and preferably about 100 denier; and it has a filament count in the range of about 34 filaments to 200 filaments. Preferably, the micro-denier filament stitch yarn has a denier per filament (dpf) in the range of about 3 dpf to 0.5 dpf, and preferably about 0.7 dpf. The fabric body comprises a prebody formed by reverse plaiting, circular knitting, with the micro-denier filament loop yarn overlaying the micro-denier filament stitch yarn at the technical face and disposed in loops at the technical back of the fabric body. The knitted fabric body comprises hydrophobic material. The knitted fabric body, e.g. at least one of the loop yarn and stitch yarn, comprises heat sensitive material. The heat sensitive material is selected from the group consisting of polyester, polypropylene, and nylon, and an elastomeric, e.g. spandex, may also be added. The heat sensitive material comprises hot melt material. The stitch yarn comprises hot melt material. Preferably, the stitch yarn comprises a cored yarn comprising a core and a sheath, the sheath comprising the hot melt material. More preferably, the core comprises a material selected from the group consisting of polyester and nylon, and/or the hot melt material is selected from the group consisting of polyethylene, polyester and polyamide.

According to another aspect of the invention, a method of forming a double-face velour knitted fabric body comprises the steps of: joining, by a knitting process, a micro-denier filament loop yarn and a micro-denier filament stitch yarn to form a fabric prebody, the micro-denier filament stitch yarn forming a technical face of the fabric prebody and the micro-denier filament loop yarn forming a technical back of the fabric prebody, and finishing the technical face and the technical back of the fabric prebody, thereby to form a double-face velour knitted fabric body having opposite velour surfaces and a permeability of about 80 ft³/ft²/min, or less, under a pressure difference of ½ inch of water across the knitted fabric body, according to the testing method of ASTM Designation: D 737-96, “Standard Test Method for Air Permeability of Textile Fabrics,” the entire disclosure of which is incorporated herein by reference.

Preferred embodiments of this aspect of the invention may include one or more the following additional features. The method comprises forming the fabric prebody by a reverse plaiting circular knitting process, with the micro-denier filament loop yarn overlaying the micro-denier filament stitch yarn at the technical face and forming in loops at the technical back of the fabric prebody. The method further comprises the step of treating at least one of the micro-denier filament stitch yarn and the micro-denier filament loop yarn of the fabric prebody to be hydrophobic. The method further comprises the steps of forming the fabric prebody with at least one of the loop yarn and the stitch yarn comprising heat sensitive material, and heat treating the fabric to increase tortuosity and dynamic insulation performance. The method comprises the step of forming the fabric prebody with the stitch yarn comprising hot melt material. The method comprises the step of forming the fabric prebody with the stitch yarn in the form of a cored yarn comprising a core and a sheath, the sheath comprising hot melt material. The method comprises the step of heat treating the fabric prebody during dyeing and/or during finishing.

An objective of the invention is to provide double-face velour fabric articles having improved dynamic insulation performance while avoiding increased weight and/or loss of stretch and/or loss of flexibility.

A further objective is to provide double-face velour fabric articles that may be worn in chilling, windy conditions without markedly diminished insulation performance.

Other features and advantages of the invention will be apparent from the following description of a presently preferred embodiment, and from the claims.

### BRIEF DESCRIPTION OF THE DRAWINGS

FIG. 1 is a somewhat diagrammatic end section view of a double-face fabric prebody, e.g., as formed in a reverse plaiting circular knitting process.

FIG. 2 is a somewhat diagrammatic end section view of a double-face velour fabric article of the invention formed by finishing the double-face fabric prebody of FIG. 1; and

FIG. 3 is a somewhat diagrammatic end section view of a prior art double-face velour fabric article which is comparable to the double-face velour fabric article of FIG. 2.

FIG. 4 is a perspective view of a segment of a circular knitting machine, and FIGS. 5-11 are sequential views of a cylinder latch needle in a reverse plaiting circular knitting process, e.g., for use in forming the double-face fabric prebody of FIG. 1.

FIG. 12 is a plot of curves showing the relationship between change in effective thermal insulation and wind velocity for covers or fabrics of different permeability (P. Larose, “The Effect of Wind on the Thermal Resistance of Clothing with Special Reference to the Protection Given by Coverall Fabrics of Various Permeabilities,” Canadian Journal of Research, Vol. 25, Sec. A, No. 4, (July, 1947), pp. 169-190.).

FIG. 13 is a somewhat diagrammatic end section view of another embodiment of a double-face velour fabric article of the invention formed by heat treatment of a double-face fabric prebody containing heat sensitive materials during dyeing and/or finishing; and

FIG. 14 is a somewhat diagrammatic end section view of still another embodiment of a double-face velour fabric article of the invention formed by heat treatment of a double-face fabric prebody containing hot melt material during dyeing and/or finishing.

### DESCRIPTION OF THE PREFERRED EMBODIMENTS

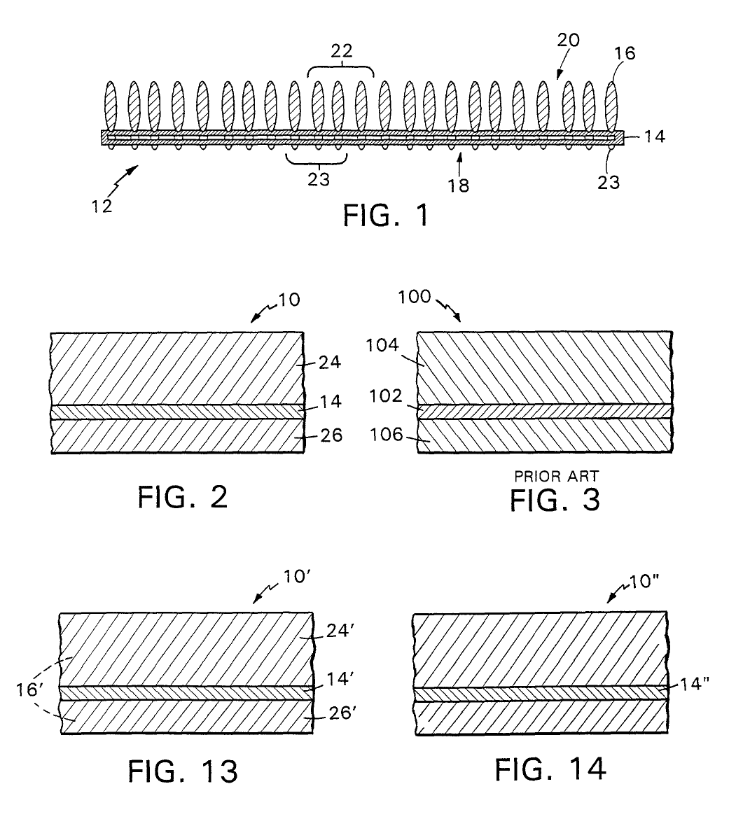

Referring to FIG. 1, a double-face fabric prebody 12, e.g. for use in forming a double-face velour fabric article 10 of the invention (FIG. 2), is formed by joining a stitch yarn 14 and a loop yarn 16 in a standard reverse plaiting circular knitting (terry knitting) process (see FIGS. 3-10), e.g. as described in Knitting Technology, by David J. Spencer (Woodhead Publishing Limited, 2nd edition, 1996), the entire disclosure of which is incorporated herein by reference. In the terry knitting process, the stitch yarn 14 forms the technical face 18 of the resulting fabric prebody 12 and the loop yarn 16 forms the opposite technical back 20, where it is formed into loops 22. In the fabric prebody 12 formed by reverse plaiting circular knitting, the loop yarn 16 extends outwardly to overlie and cover the stitch yarn 14 at the technical face 18.

The loop yarn 16 forming the technical back 20 of the knit fabric body 12 can be made of any synthetic or natural material. The cross section and luster of the fibers or the filaments may be varied, e.g., as dictated by requirements of the intended end use. The loop yarn 16 can be a textured or flat micro-denier filament yarn, with a textured yarn being preferred for relatively greater dynamic insulating effect, as discussed below. The loop yarn overall denier is typically in the range of about 70 denier to 300 denier, with a preferred count of about 150 denier. At the preferred count, the filament count range is from about 100 filaments to 300 filaments, therefore providing a denier per filament (dpf) of from 1.5 to 0.5, respectively. A relatively smaller dpf, e.g., 1 dpf, is preferred for relatively greater dynamic insulating effect, as will be discussed below. A preferred commercial loop yarn is a 150/132 denier textured polyester micro-denier filament with a dpf of 1.14, e.g., as available from UNIFI, Inc., of Greensboro, N.C.

The stitch yarn 14 forming the technical face 16 of the knit fabric body 12 can be also made of any type of synthetic or natural material in a textured or flat micro-denier filament yarn, with a textured yarn being preferred for relatively greater dynamic insulating effect. The range of stitch yarn count denier is typically between about 50 denier to 150 denier. Where the loop yarn is 150/132 textured, the preferred stitch yarn count is about 100 denier, and the filament count ranges from about 34 filaments to 200 filaments, i.e. 100/34 to 100/200, resulting in dpf from about 3 dpf to 0.5 dpf, with relatively finer filaments being preferred, again, for relatively greater dynamic insulating performance. A preferred yarn is 100/136 denier textured polyester micro-denier filament yarn with about 0.7 dpf, e.g. as available commercially from UNIFI, Inc.

From these examples, it can be seen that, for achieving markedly improved dynamic insulating performance, use of a textured 150/132 loop yarn and a textured 100/136 stitch yarn is preferred.

In comparison, in a prior art double-face velour fabric article (100, FIG. 3) without the improved dynamic insulation performance of the present invention, a typical stitch yarn 102 is 70/34 denier filament textured polyester, with individual fiber fineness of greater than 2.0 dpf, e.g. as available commercially from UNIFI, Inc.

In a preferred method of the invention, the fabric prebody 12 is formed by reverse plaiting on a fine cut circular knitting machine (e.g., 28 cut). This is principally a terry knit construction, where segments 22 of the loop yarn 16 cover the stitch yarn 14 on the technical face 18 and loops 23 of the loop yarn 16 form loops 23 at the technical back 20 of the fabric prebody 12 (see FIG. 1).

The fabric prebody 12 is next subjected to finishing. During the finishing process, the technical face and technical back surfaces 18, 20, respectively, of the fabric prebody 12, with the segments 22 of loop yarn 16 overlying the stitch yarn 14 at the technical face surface 18 and the loops 23 formed at the technical back surface 20, go through finishing processes such as sanding, brushing or napping, to generate a velour 24, 26. The yarn fibers are raised at both faces of the fabric prebody 12 (FIG. 1), including the technical face 18 and the technical back 20, to form the velour 24, 26 of the double-face velour fabric article 10 (FIG. 2) of the invention. The fabric prebody 12 and/or fabric body 10 may also be treated, e.g., chemically, to make it hydrophobic.

After finishing, the fabric article 10 is heat set to stabilize the fabric article width.

In the resulting double-face velour fabric article 10 of the invention, the overall density, i.e. weight per length, of the micro-denier filament stitch yarn 14 is closely comparable to stitch yarn 102 used in a comparable prior art fabric article 100 having velour 104, 106 at the opposite faces. The diameter of the micro-denier filament stitch yarn 14 is slightly greater than that of the prior art stitch yarn 102 (likely due to increased filament-to-filament engagement of the micro-denier filaments of the micro-denier filament yarn 14). The yarn count and gauge of the double-face velour fabric article 10 of the invention are also substantially the same as that of the comparable prior art fabric article 100. As a result, the weight and stretch performance of the double-face velour fabric article 10 of the invention is closely comparable to the weight and stretch of the prior art double-face velour fabric article 100 of the same gauge and yarn count.

The fact that the weight density of the micro-denier filament stitch yarn 14 and the stitch yarn 102 are the same indicates that the ratios of yarn material to open volume of the respective articles are also approximately the same. However, in the micro-denier filament stitch yarn 14, and in the resulting double-face velour fabric article 10 of the invention, the average cross sectional area of the individual filaments is considerably less that the average cross sectional area of filaments in the stitch yarn 102 employed in the comparable prior art fabric article 100, e.g. the denier per filament (dpf) of the preferred micro-denier filament stitch yarn 14 is about 0.7 dpf, as compared to 3.0 dpf for the stitch yarn 102 of comparable prior art fabric article 100. As a result, the paths for passage of air, e.g. a chilling wind, through double-face velour fabric article 10 of the invention, while relatively more numerous, are also considerably smaller and relatively more tortuous, as compared to a comparable prior art double-face velour fabric article 100. The enhanced performance of the fabric article of the invention is achieved by increasing the yarn count and the filament count to make the paths through the fabric more tortuous, thus making it more difficult for air, i.e., a chilling wind, to penetrate quickly through the double-face velour fabric article 10 of the invention. As a result, the dynamic insulation performance of the double-face velour fabric of the invention is dramatically increased over the prior art.

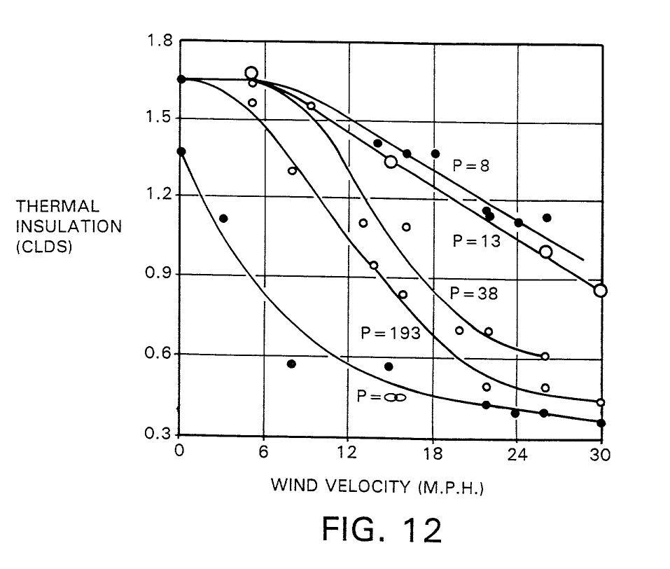

In FIG. 12, there is reproduced a plot of curves showing the relationship between change in effective thermal insulation and wind velocity for covers or fabrics of different permeabilities, as appeared in an article by P. Larose, entitled “The Effect of Wind on the Thermal Resistance of Clothing with Special Reference to the Protection Given by Coverall Fabrics of Various Permeabilities,” which appeared in Canadian Journal of Research (Vol. 25, Sec. A, No. 4, (July, 1947), pp. 169-190). The permeabilities of the materials tested varied between 0 and 193 ft³/ft²/min under a pressure difference of ½ inch of water across the fabric.

In particular, it can be seen in the plot that at zero wind velocity there is relatively little difference in insulating performance among the materials tested. The dynamic insulating performance for each of the materials tested also decreased with increasing wind velocity. However, as may be seen in the plot, the rate of decrease in dynamic insulating performance was much more precipitous in fabrics of relatively greater permeability, i.e. as permeability increased, the rate of loss of dynamic insulating performance with increasing wind velocity was relatively smaller for fabrics of low permeability, as compared to fabrics having relatively greater permeability.

The word “tortuosity” is used to describe the fabric property enhanced according to the invention by increasing yarn count and filament count. The paths through the fabric are made more “tortuous” than those of prior art fabrics, and greater “tortuosity” results in greater dynamic insulating effect. In addition, if a given fabric body is subjected to less than normal stretching, resulting in reduced final width of the fabric (i.e., the width resulting after heat setting of the fabric during the finishing process), the higher, still, the dynamic insulating performance of the resulting fabric article of the invention.

In Table A (below), the improvement in dynamic insulation performance of double-face velour fabric articles 10 (FIG. 2) of the invention in a chilling wind can easily be seen when compared to the performance of a comparable prior art double-face velour fabric article 100 (FIG. 3). In particular, the double-face velour fabric article 10 of the invention has considerably better dynamic insulating performance, and good static (no wind) and dynamic (windy) insulation performance, due to the increased tortuosity of air paths through the fabric, with good stretch properties and light weight.

TABLE A

| | A₁ | A₂ | B₁ | B₂ |
|---|---|---|---|---|
| Loop Yarn | 150/100 | 150/132 | 150/100 | 150/132 |
| | textured | textured | textured | textured |
| Stitch Yarn | 100/34 | 100/34 | 100/34 | 100/34 |
| | textured | textured | textured | textured |
| Width | 58-inch | 58-inch | 54-inch | 54-inch |
| | cuttable | cuttable | cuttable | cuttable |
| Dynamic | 100-110 | 60-70 | 70-80 | 50-60 |
| Insulating | | | | |
| Performance | | | | |

| | | |
|---|---|---|
| Compare: | A₁ to A₂ | A₂ has finer loop yarn, and therefore |
| | | relatively better dynamic insulating |
| | | performance. |
| Compare: | A₁ to B₁ | B₁ has narrower width, and therefore |
| | | better dynamic insulating |
| | | performance. |
| Compare: | A₁ to B₂ | B₂ has finer loop yarn, and therefore |
| | | better dynamic insulating |
| | | performance. |
| Compare: | A₁ to B₂ | B₂ has finer loop yarn and narrower |
| | | width, and therefore better dynamic |
| | | insulating performance |

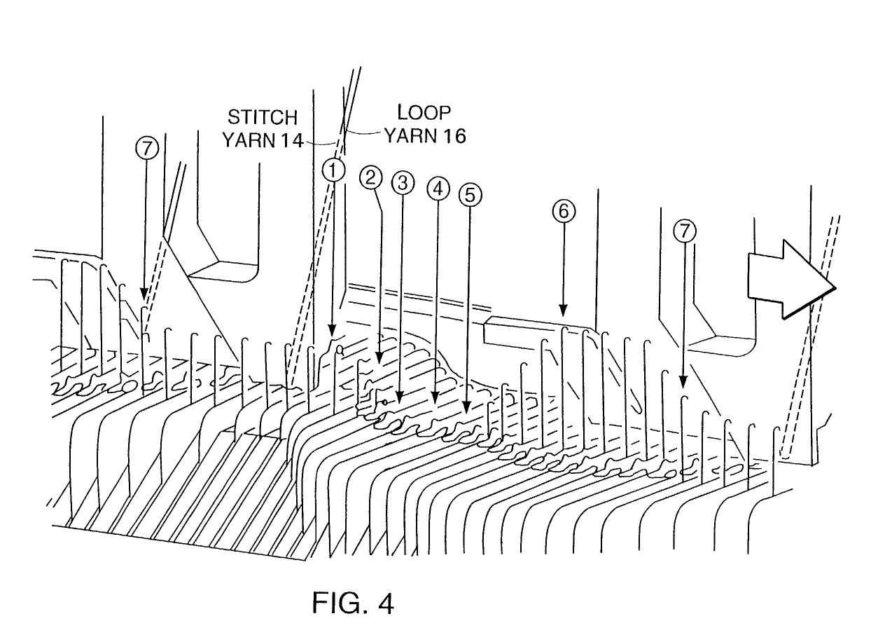

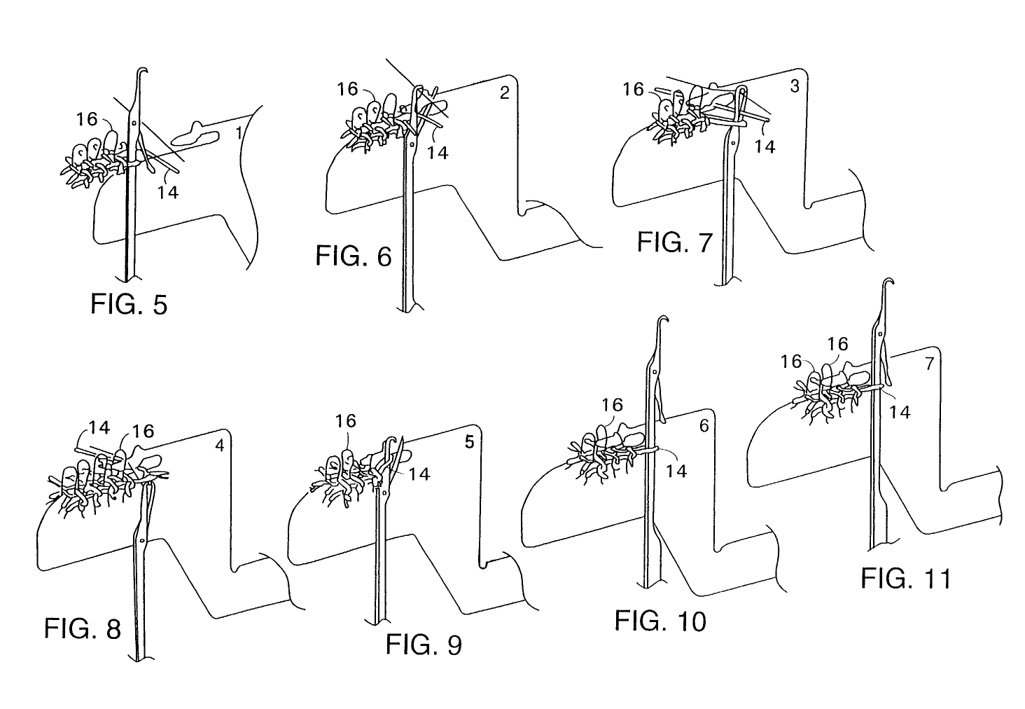

Referring now to FIG. 13, in another embodiment of the invention, a fabric article 10′ of the invention formed by reverse plaiting on a fine cut circular knitting machine (FIGS. 4-11) includes a stitch yarn 14′ and a loop yarn 16′ finished into a velour 24′, 26′ at the opposite surfaces. The stitch yarn 14′ and/or the loop yarn 16′ comprise micro-denier yarn or filaments of heat sensitive, i.e. heat shrinkable, material. Suitable materials include polyester, polypropylene, nylon and the like. An elastomeric yarn, e.g. such as spandex, may also be included, but typically only to the stitch yarn. A result of heating the fabric during dyeing and/or finishing is that the filaments of heat sensitive material shorten and thicken, and/or reduce in effective length, thus further reducing the paths for passage of chilling wind through the fabric to increase the tortuosity and the dynamic insulation performance of the fabric article 10′ of the invention.

Referring to FIG. 14, in another embodiment, the stitch yarn 14″ may include a cored yarn having a core formed of, e.g., polyester or nylon, and a sheath formed of a heat sensitive material, e.g., a hot melt material, such as polyethylene, polyester or polyamide, as available commercially from Engineered Yarn Company, of Fall River, Mass. A result of heating the fabric of this embodiment during dyeing and/or finishing is that the sheath of hot melt material fuses, thus further reducing the paths for passage of chilling wind through the fabric to increase the tortuosity and the dynamic insulation performance of the fabric article 10″ of the invention.

Furthermore, due to the increased tortuosity after heat treatment, the fabric article 10′ formed with heat sensitive fibers and the fabric article 10″ formed with a cored yarn having a sheath of hot melt material have enhanced dynamic insulation performance, e.g. as compared to the fabric article 10 having the same weight. As a result, the fabric articles 10′, 10″ are particularly suited for use, e.g., in light weight clothing and the like for use in extreme conditions of chilling wind and cold temperature.

Other embodiments are within the following claims. For example, any type of yarn may be employed. Also, other suitable methods of constructing a velour fabric article of the invention may be employed. For example, in the preferred embodiment described above, the construction provided by reverse plaiting is employed in order to expose the loop yarn 16 for finishing at both surfaces of the fabric body, with segments 22 of the loop yarn 16 overlaying the stitch yarn 14 at the technical face 18 and formed into loops 23 at the technical back 20. This is preferred, for reasons of dynamic insulation performance, over a construction in which only the loop yarn is finished. However, where improvement of dynamic insulation performance is the primary or an overwhelming consideration, a construction exposing the stitch yarn and the loop yarn side by side for finishing at one or both surfaces of a fabric body may be preferred.

What is claimed is:

1. A double-face velour fabric article consisting of a knitted fabric body having a technical face formed by a micro-denier filament stitch yarn and a technical back formed by a micro-denier filament loop yarn, said fabric body having a velour surface formed at both said technical back and said technical face, and said fabric body having a permeability of about 80 ft³/ft²/min, or less, under a pressure difference of ½ inch of water across the knitted fabric body.

2. The double-face velour fabric article of claim 1, wherein said micro-denier filament loop yarn is textured.

3. The double-face velour fabric article of claim 1, wherein said micro-denier filament loop yarn has an overall denier in the range of about 70 denier to 300 denier.

4. The double-face velour fabric article of claim 3, wherein the overall denier of said micro-denier filament loop yarn is about 150 denier.

5. The double-face velour fabric article of claim 4, wherein said micro-denier filament loop yarn has a filament count in the range of about 100 filaments to 300 filaments.

6. The double-face velour fabric article of claim 5, wherein said micro-denier filament loop yarn has a denier per filament (dpf) in the range of about 1.5 dpf to 0.5 dpf.

7. The double-face velour fabric article of claim 6, wherein the denier per filament of said micro-denier filament loop yarn is about 1 dpf.

8. The double-face velour fabric article of claim 1, wherein said micro-denier filament stitch yarn is textured.

9. The double-face velour fabric article of claim 1, wherein said micro-denier filament stitch yarn has an overall denier in the range of about 50 denier to 150 denier.

10. The double-face velour fleece fabric article of claim 7 or 9, wherein said micro-denier filament stitch yarn has an overall denier of about 100 denier.

11. The double-face velour fabric article of claim 10, wherein said micro-denier filament stitch yarn has a filament count in the range of about 34 filaments to 200 filaments.

12. The double-face velour fabric article of claim 11, wherein said micro-denier filament stitch yarn has a denier per filament (dpf) in the range of about 3 dpf to 0.5 dpf.

13. The double-face velour fabric article of claim 12, wherein the denier per filament of said micro-denier filament stitch yarn is about 0.7 dpf.

14. The double-face velour fabric article of claim 1, wherein said fabric body comprises a prebody formed by reverse plaiting, circular knitting, with the micro-denier filament loop yarn overlaying the micro-denier filament stitch yarn at the technical face and disposed in loops at the technical back of the fabric body.

15. The double-face velour fabric article of claim 1, wherein said knitted fabric body comprises hydrophobic material.

16. The double-face velour fabric article of claim 1, wherein said knitted fabric body comprises heat sensitive material.

17. The double-face velour fabric article of claim 1, wherein at least one of said loop yarn and said stitch yarn comprises heat sensitive material.

18. The double-face velour fabric article of claim 16 or 17, wherein said heat sensitive material is selected from the group consisting of polyester, polypropylene, and nylon.

19. The double-face velour fabric article of claim 16 or 17, further comprising elastomeric material.

20. The double-face velour fabric article of claim 19, wherein said elastomeric comprises spandex.

21. The double-face velour fabric article of claim 16, wherein said heat sensitive material comprises hot melt material.

22. The double-face velour fabric article of claim 21, wherein said stitch yarn comprises hot melt material.

23. The double-face velour fabric article of claim 22, wherein said stitch yarn comprises a cored yarn comprising a core and a sheath, said sheath comprising said hot melt material.

24. The double-face velour fabric article of claim 23, wherein said core comprises a material selected from the group consisting of polyester and nylon.

25. The double-face velour fabric article of claim 21, 22 or 23, wherein said hot melt material is selected from the group consisting of polyethylene, polyester and polyamide.

26. A method of forming a double-face velour knitted fabric body, said method comprising the steps of:
joining, by a knitting process, a micro-denier filament loop yarn and a micro-denier filament stitch yarn to form a fabric prebody, the micro-denier filament stitch yarn forming a technical face of the fabric prebody and the micro-denier filament loop yarn forming a technical back of the fabric prebody, and
finishing said technical face and said technical back of the fabric prebody, thereby to form a double-face velour knitted fabric body having opposite velour surfaces and a permeability of about 80 ft³/ft²/min, or less, under a pressure difference of ½ inch of water across the knitted fabric body.

27. The method of claim 26, comprising forming the fabric prebody by a reverse plaiting circular knitting process, with the micro-denier filament loop yarn overlaying the micro-denier filament stitch yarn at the technical face and forming in loops at the technical back of the fabric prebody.

28. The method of claim 26 further comprising the step of treating at least one of the micro-denier filament stitch yarn and the micro-denier filament loop yarn of said fabric prebody to be hydrophobic.

29. The method of claim 26 further comprising the steps of forming the fabric prebody with at least one of the loop yarn and the stitch yarn comprising heat sensitive material, and heat treating the fabric to increase tortuosity and dynamic insulation performance.

30. The method of claim 29 comprising the step of forming the fabric prebody with the stitch yarn comprising hot melt material.

31. The method of claim 30 comprising the step of forming the fabric prebody with the stitch yarn in the form of a cored yarn comprising a core and a sheath, the sheath comprising hot melt material.

32. The method of claim 29, 30 or 31 comprising the step of heat treating the fabric prebody during dyeing.

33. The method of claim 32 comprising the further step of heat treating the fabric prebody during finishing.

34. The method of claim 29, 30 or 31 comprising the step of heat treating the fabric prebody during finishing.
